(19) United States
(12) Patent Application Publication
(10) Pub. No.: US 2014/0052633 A1
(43) Pub. Date: Feb. 20, 2014

(54) PAYMENT IN A CHAT SESSION

(71) Applicant: Saumil Ashvin Gandhi, Sunnyvale, CA (US)

(72) Inventor: Saumil Ashvin Gandhi, Sunnyvale, CA (US)

(73) Assignee: eBay Inc., San Jose, CA (US)

(21) Appl. No.: 13/586,052

(22) Filed: Aug. 15, 2012

(51) Int. Cl. G06Q 20/40

(52) U.S. Cl. 705/44

(57) ABSTRACT

Methods and systems for facilitating payments in a chat session are described. The methods include receiving instructions from a first user to configure a chat session to accept actionable text regarding payment, receiving the actionable text in a message entered by the first user to a second user, determining an action for the first user based on the actionable text, transmitting a request for the action to a second user, receiving approval of the request from the second user, and processing the payment.

### BACKGROUND

1. Field of the Invention

The present disclosure generally relates to financial transactions during a chat session.

2. Related Art

More and more consumers are purchasing items and services over electronic networks, such as the Internet. Consumers routinely need and purchase products and services from merchants, service providers and individuals alike. Likewise, merchants, service providers and individuals are billing those that purchase from them, i.e., clients, via on-line, electronic mail or text-message invoicing or billing. The transactions can take place directly between a company, merchant or retailer and the consumer, where payment is typically made by entering credit card or other financial information. Transactions can also take place with the aid of a payment provider, such as PayPal, Inc. of San Jose, Calif. Such payment providers can make transactions easier and safer for the parties. Payment providers enable payments to be made through many different convenient methods.

Chat services and instant messaging on the Internet provide for real time communication between two users via a computer, wireless device, or any other text based communication apparatus. Once a chat has been initiated, either user may enter text by typing on an interface, and the entered text will appear on the other user's display. The messages are generated and displayed by an instant messaging/chat client on each end and an instant messaging/chat server may perform various functions to facilitate the transfer of messages. Most networks and online services offer some type of chat feature. With chat programs, communication is often quick and swift, allowing for remote direction of instructions, discussions, and other pertinent conversations.

However, there is no current secure way to make payments through a chat session. Thus, it is desirable to provide alternative methods and systems that facilitate financial transactions during a chat session.

### BRIEF DESCRIPTION OF THE DRAWINGS

FIG. 1 is a block diagram of a networked system suitable for implementing the methods described herein according to an embodiment;

FIG. 2 is a flowchart showing a method of facilitating payment in a chat session according to one embodiment;

FIG. 3 is a flowchart showing a method of facilitating payment in a chat session according to another embodiment; and

FIG. 4 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

A sender or first user in a chat session configures a chat to accept certain text, e.g., a combination of emoticons or a string of text or symbols, as actionable for payment (“actionable text”). When the sender types or otherwise enters in the actionable text in a message, the actionable text or symbols triggers a payment module operated by a payment provider, such as PayPal, Inc. of San Jose, Calif., to send an alert of the request to a recipient of the message or second user. The recipient receives the alert, accepts the request, and triggers transfer of the funds to or from the recipient's account managed by the payment provider.

In one embodiment, a sender or first user configures a chat to accept actionable text to trigger payment during a chat session. Once the chat session is established, the sender types or otherwise enters the actionable text in a message and the payment provider receives the message with the actionable text. The payment provider sends a request or alert to the recipient of the message or second user, receives approval of the request from the second user, and processes payment of the request based on the correct interpretation of the text sent. Processing the payment may either be transferring funds from a first user account managed by the payment provider to a second user account managed by the payment provider, or vice versa.

In another embodiment, the sender configures the chat to accept the actionable text or symbols or a combination of the same to trigger payment and types in or otherwise enters the actionable text in a message to the recipient. The payment provider sends an alert or request to the recipient, and the recipient has the choice to accept or decline the request. If the recipient declines the request, the sender has the option of re-submitting the request by typing or otherwise entering a second message with actionable text for a second payment amount different from the payment amount previously sent. The payment provider sends a second alert or request, and the recipient has the option again to approve or decline the request.

Both the sender and recipient of the actionable text should register with the payment provider, and should be able to send and receive payment from the payment provider. The sender and recipient may be individuals or merchants with good or services for sale. Registration may include signing up for the service and agreeing to any terms required by the payment provider, such as through a client device. In one embodiment, the client device is a mobile computing device, such as a smart phone, a PC, or a computing tablet. In other embodiments, registration may be done completely through the client device, partially through the client device, or without using the client device, such as through a phone call or in-person visit to a representative of the payment provider.

The sender and recipient may be requested to provide specific information for registration, such as, but not limited to, a user name, phone number, email address, credit card information, bank information, social security or tax ID number, a user name for the account, and a password or PIN for the account. If the sender or recipient is a merchant, requested information may include type of goods/services offered, address, location(s) of planned sales, phone number, email address, and website address (if applicable). The type of information requested may depend on whether the sender or recipient already has an account with the payment provider. Even if the sender or recipient has an account, the sender or recipient may be requested to register for this particular service, such as by providing specific information and agreeing to certain teens and conditions. Requested information may be entered through the client device or other means, including voice or manual key entry. Once all the requested information is received and confirmed, the payment provider may create an account for the sender and recipient and/or offer the service to the sender and recipient.

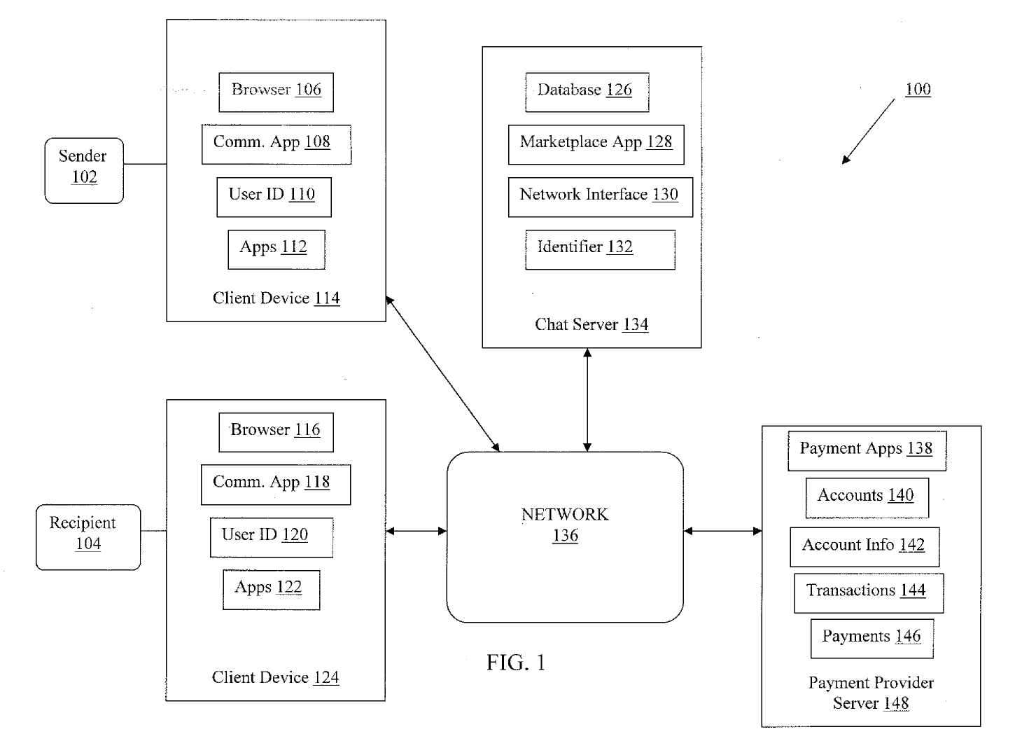

FIG. 1 is a block diagram of a networked system 100 configured to handle a financial transaction between a sender 102 and a recipient 104, such as described herein, in accordance with an embodiment of the present disclosure. System 100 includes a first client device 114, a second client device 124, a chat server 134, and a payment provider server 148 in communication over a network 136. Payment provider server 148 may be maintained by a payment provider, such as PayPal, Inc. of San Jose, Calif. Sender 102, utilizes first client device 114, and recipient 104 utilizes second client device 124, where the first client device 114 is used to send a message with actionable text regarding payment to the second client device 124 and the second client device 124 is used to receive the actionable text regarding payment from the first client device 114 and perform a payment transaction using payment provider server 148.

First client device 114, second client device 124, chat server 134, and payment provider server 148 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 136.

Network 136 may be implemented as a single network or a combination of multiple networks. For example, in various embodiments, network 136 may include the Internet or one or more intranets, landline networks, wireless networks, and/or other appropriate types of networks.

First client device 114 and second client device 124 may be implemented using any appropriate hardware and software configured for wired and/or wireless communication over network 136. For example, in one embodiment, the two client devices may be implemented as a personal computer (PC), a smart phone, a mobile phone, personal digital assistant (PDA), laptop computer, and/or other types of computing devices capable of transmitting and/or receiving data, such as an iPad™ from Apple™.

First client device 114 may include one or more browser applications 106 which may be used, for example, to provide a convenient interface to permit sender 102 to browse information available over network 136. For example, in one embodiment, browser application 106 may be implemented as a web browser configured to view information available over the Internet. First client device 114 may also include one or more applications 112 which may be used, for example, to provide client-side processing for performing desired tasks in response to operations selected by sender 102. In one embodiment, a toolbar application may display a user interface in connection with browser application 106 as further described herein. First client device 114 may further include other applications 112 as may be desired in particular embodiments to provide desired features to first client device 114. For example, other applications 112 may include security applications for implementing client-side security features, programmatic client applications for interfacing with appropriate application programming interfaces (APIs) over network 136, or other types of applications. Applications 112 may also include email, texting, voice and instant messaging (IM) applications that allow sender 102 to send and receive emails, calls, and texts through network 136, as well as applications that enable sender 102 to request and receive payments through the payment provider as discussed below. First client device 114 includes one or more user identifiers 110 which may be implemented, for example, as operating system registry entries, cookies associated with browser application 106, identifiers associated with hardware of first client device 114, or other appropriate identifiers, such as used for payment/user/device authentication. The user identifier 110 may include attributes related to first client device 114, such as identification information (e.g., a location address, Global Positioning System (GPS) coordinates, a network identification number, etc.). In one embodiment, user identifier 110 may be used by a payment provider to associate sender 102 with a particular account maintained by the payment provider as further described herein. A communications application 108, with associated interfaces, enables first client device 114 to communicate within system 100 and may be used to send a request message to recipient 104, such as via text messaging. In another embodiment, chat server software is present on first client device 114.

Second client device 124 may have similar applications and modules as first client device 114, but is used, in this example, for receiving messages sent by sender 102 via the first client device 114 and for approving payment requests sent via sender 102 through use of a payment provider. Restrictions, limitations, and conditions may be placed for each designated sender. Second client device 124 may also include one or more browser applications 116 and one or more applications 122 which may be used, for example, to provide a convenient interface to permit recipient 104 to browse information and perform tasks over network 136. For example, in one embodiment, browser application 116 may be implemented as a web browser configured to view information available over the Internet and communicate with payment provider server 148 to receive and send information about payment based on a request message from sender 102.

Second client device 124 may further include other applications 122 such as security applications for implementing client-side security features, programmatic client applications for interfacing with appropriate application programming interfaces (APIs) over network 136, or other types of applications. Applications 122 may also include email, text, IM, and voice applications that allow recipient 104 to communicate through network 136, receive messages from sender 102, and create and manage funding sources. Second client device 124 includes one or more user identifiers 120 which may be implemented, for example, as operating system registry entries, cookies associated with browser application 116, identifiers associated with hardware of second client device 116 such as location address or GPS coordinates, or other appropriate identifiers, such as used for payment/recipient/device authentication, e.g., the phone number associated with second client device 116. Identifiers may be used by a payment provider to associate recipient 104 with a particular account maintained by the payment provider. In one embodiment, chat server software is present on second client device 124.

The chat server 134 may be maintained, for example, by a chat server administrator. The chat server 134 facilitates communication between sender 102 and recipient 104 by transmitting messages between the first client device 114 and the second client device 124. The chat server 134 includes a database 126 to store a user's number, a pseudo identity, and a list of related users to a user (i.e., their buddy list), as well as specific text for a user to conduct payment or financial transactions during a chat session. The chat server 134 may also include a marketplace application 128, which may be configured to serve information over network 136 to browser 106 of first client device 114 and, optionally, the second client device 124.

The chat server 134, in one embodiment, may include at least one network interface component (NIC) 130 adapted to communicate with the network 136. In various examples, the network interface component 132 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The chat server 134, in various embodiments, may include one or more other applications to provide additional features. For example, these other applications may include security applications for implementing client-side security features, programmatic client applications for interfacing with appropriate application programming interfaces (APIs) over the network 136 or various other types of generally known programs and/or applications.

The chat server 134, in one embodiment, may include one or more identifiers 132, which may be implemented as operating system registry entries, cookies associated with the an interface application, identifiers associated with hardware of the chat server 134, and/or various other appropriate identifiers. The identifier 132 may include attributes related to the chat server 134, such as identification information (e.g., a system serial number, a location address, Global Positioning System (GPS) coordinates, a network identification number, etc.) and network information (e.g., network owner, network provider, network administrator, network security information, etc.). In various implementations, the identifier 132 may be passed with network traffic data and information to the payment provider server 148, and the identifier 132 may be used by the payment provider server 148 to associate one or more network transactions of the sender 102 and/or recipient 104 with one or more particular user accounts maintained by the payment provider server 148.

Payment provider server 148 may be maintained, for example, by an online payment provider, which may provide payment between recipient 104 and sender 102. In this regard, payment provider server 148 includes one or more payment applications 138, which may be configured to interact with first client device 114, second client device 124, and/or chat server 134 over network 136 to facilitate payment between sender 102 and recipient 104.

Payment provider server 148 also maintains a plurality of user accounts 140, each of which may include account information 142 associated with individual users. For example, account information 142 may include private financial information of users of devices such as account numbers, passwords, device identifiers, user names, phone numbers, credit card information, bank information, or other financial information which may be used to facilitate online transactions by recipient 104 and optionally, by sender 102. Account information 142 may include specific text or symbols associated with a user account to enable the user to send or receive funds during a chat session as described herein. Advantageously, payment application 138 may be configured to interact with chat server 134 on behalf of recipient 104 during a financial transaction to track and manage funds transferred between sender 102 and recipient 104.

A transaction processing application 144, which may be part of payment application 138 or separate, may be configured to receive information from a client device and/or chat server 134 for processing and storage in a payment database 146. Transaction processing application 144 may include one or more applications to process information from sender 102 and/or recipient 104 for processing a payment as described herein. Payment application 138 may be further configured to determine the existence of and to manage accounts for recipient 104, and optionally sender 102, as well as create new accounts if necessary, such as the set up, management, and use of various funding sources.

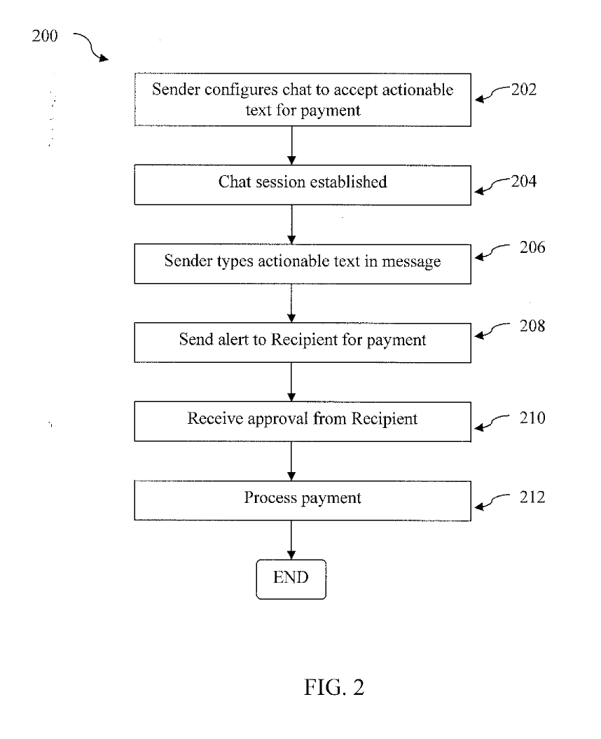

FIG. 2 is a flowchart 200 showing a method of facilitating payment in a chat session, according to one embodiment. At step 202, sender 102 configures or sets up a chat to accept actionable text regarding payment. This may include entering or otherwise supplying a phone number or other contact information for another person (e.g., recipient 104) to chat with, such as accessing a chat, message, or text application on the user device. The actionable text may include any customized arrangement or combination of letters, numbers, and/or symbols. For example, sender 102 may configure the chat so that the dollar sign symbol “$” triggers a financial transaction between sender 102 and recipient 104. Thus, when sender 102 types, “Here's the $25 I promised you,” payment to recipient 104 may be activated. In one embodiment, various emoticons such as smiley faces :) :o) :] : 3: c), laughing faces :-D :D 8-D 8D x-D xD, or even angry faces :-∥ :@ can be configured to trigger payment. In another embodiment, the actionable text may be quantified to correlate to a certain dollar amount. For example, “$” can be set up to mean $10, while “$$” can be set up to mean $20. Any variety of numbers, symbols, letters, and/or emoticons can be configured to trigger payment and any combination can be configured to translate into a certain dollar amount.

Sender 102 can configure the actionable text either to accept funds from recipient 104 or to transfer funds to recipient 104 during the chat session. For example, sender 102 may configure the chat so that the symbol “$?” or the message, “Can you send me $20?” triggers a request for funds to recipient 104.

Typically, sender 102 can log in to the payment provider site and configure the chat to accept the actionable text on the provider site. Alternatively, sender 102 can log in to the chat program or service and configure the chat through a plug-in in the chat program software. The chat server administrator may then configure the chat to accept the actionable text on the chat server on one or both ends.

At step 204, sender 102 or recipient 104 establishes a chat session on the chat server 134 through the network 136. In one embodiment, chat server 134 authenticates the identity of sender 102 and recipient 104 by requesting and verifying identifying information, such as a password. In another embodiment, text messages between sender 102 and recipient 104 are protected, i.e., encrypted, so that unauthorized readers cannot view the messages. In yet another embodiment, the text messages are stored in an encrypted format and are decrypted in response to the verification of the indentifying information. For more open communication, such as Skype to Skype, an additional layer of security or a second factor of authentication may be added.

One of the participants in the chat session, such as sender 102, then types or otherwise enters a message into a text field of the chat session. The chat server 134 sends the message to the other participants in the chat session, such as recipient 104, and the message is displayed in the chat session window of the other participants. Other participants in the chat session can similarly enter and send messages to the other participants in the chat session.

At step 206, sender 102 types in or otherwise enters actionable text to make or receive a payment. For example, the sender may speak a text symbol or choose a text from a menu. The actionable text may be received by one or more participants in the chat session, including recipient 104. The actionable text causes a payment provider application programming interface (API), such as PayPal send API, to start. PayPal send API allows PayPal software to communicate with the chat program software to facilitate financial transactions between sender 102 and recipient 104 without either user leaving the chat session. A payment request from chat server 134 is sent to payment provider server 148, and payment provider server 148 responds to the request.

At step 208, payment provider server 148 responds to the request by sending an alert for the request to the one or more participants in the chat session that received the message with the actionable text, including recipient 104. The alert can include the name of sender 102, the payment amount requested, and a button for recipient 104 to make his choice. In one embodiment, payment provider server 148 converts the currency in the sender's message to another currency in the alert sent to recipient 104. For example, the funds may be requested in U.S. dollars, but be converted to Japanese yen if recipient 104 is located in Japan. In one embodiment, the currency is automatically converted based on the location of the user, e.g., recipient 104, device. The user location may be determined by the payment provider from location information transmitted or received from the user device. For example, the user may allow the payment provider to use location information from the user device or the user may enter a specific location, such as an address, and transmit that location to the payment provider.

At step 210, recipient 104 views the alert and approves the request. Recipient 104 can click on a button within the alert indicating the recipient's choice. For example, the button(s) within the alert can indicate “Accept” or “Yes” to accept the transfer of funds, “Decline” or “No” to decline the transfer of funds, or “Not Now” to indicate that a choice will be decided upon later. Recipient 104 may also be given the option of editing or revising the request, such as changing the amount. The recipient may modify the request directly, such as changing the amount, or by sending a new request to the sender using specific text of the recipient. If the original sender request is modified, the recipient request or modification may be processed similar to a request where the recipient initiates the request.

The payment provider receives approval to transfer funds to or from recipient's account and at step 212, the payment is processed based on the correct interpretation of the actionable text sent. The processing may include debiting the appropriate amount of funds from each of the specified accounts, crediting the appropriate amount of funds to the accounts, and notifying the sender and/or recipient that the payment request has been approved. The notification may be through email, text, phone call, or notification on the recipient's account page with the payment provider. The recipient and/or sender may be informed about various details of the transaction, including amount of funds used, total amount of the transaction, and the date of the transaction.

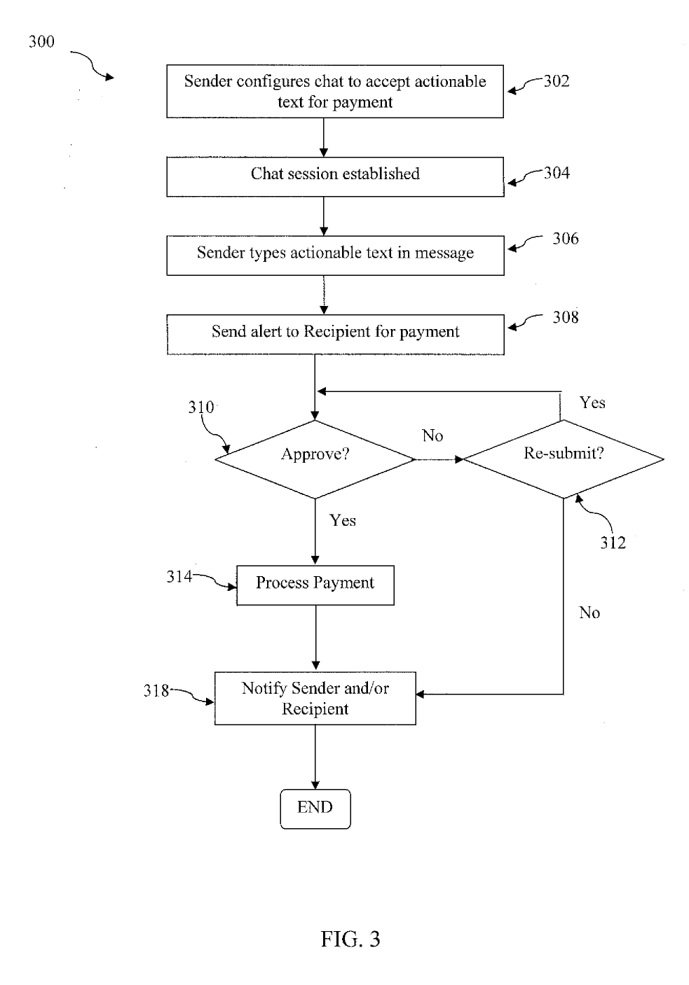

FIG. 3 is a flowchart 300 showing another embodiment of a method of facilitating payment in a chat session. Steps 302-308 are similar to steps 202-208 of FIG. 2, and thus, the descriptions of these steps are omitted for brevity.

At step 310, recipient 104 either approves, modifies, or declines the payment request. Optionally, the payment provider server 148 can notify sender 102 if recipient 104 indicates that he will not make or accept the payment or is revising any part of the payment request. In some instances, recipient 104 may click “Not Now” or not respond at all to the message. If recipient 104 does not follow-up with a response or does not respond to the message at all within a certain time period, the request may expire and notification may be sent to sender 102 that recipient 104 was not responsive.

At step 312, if the requested payment is not approved, sender 102 may re-submit the request by changing one or more parameters, such as the amount to be transferred. The request is then re-sent to recipient 104 for approval. If sender 102 does not wish to re-submit the request or sender 102 is not given the option of re-submitting (such as in the case where the reason for not approving the transaction was based on the actual type of transaction), then the transaction ends without a payment. Optionally, at step 318, sender 102 and/or recipient 104 is notified that the transaction has not been completed.

However, if the transaction request is approved, the payment provider processes the payment at step 314 based on the correct interpretation of the actionable text sent in the same manner as discussed with respect to step 212 in FIG. 2. The method 300 then proceeds to step 318, where sender 102 and/or recipient 104 are notified that the transaction has been completed.

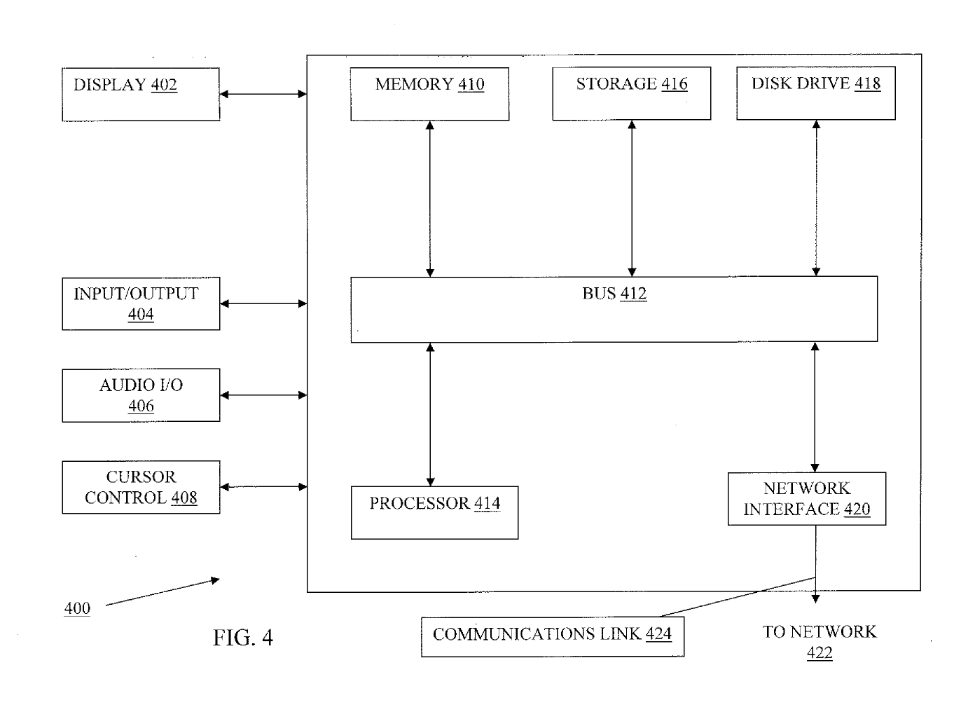

FIG. 4 is a block diagram of a computer system 400 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The chat administrator and/or payment provider may utilize a network computing device (e.g., a network server) capable of communicating with the network. It should be appreciated that each of the devices utilized by senders, receivers, third parties (i.e., chat administrators), and payment providers may be implemented as computer system 400 in a manner as follows.

Computer system 400 includes a bus 412 or other communication mechanism for communicating information data, signals, and information between various components of computer system 400. Components include an input/output (I/O) component 404 that processes a user (i.e., sender, recipient, chat administrator and/or payment provider) action, such as selecting keys from a keypad/keyboard, selecting one or more buttons or links, etc., and sends a corresponding signal to bus 412. I/O component 404 may also include an output component, such as a display 402 and a cursor control 408 (such as a keyboard, keypad, mouse, etc.). An optional audio input/output component 406 may also be included to allow a user to use voice for inputting information by converting audio signals. Audio I/O component 406 may allow the user to hear audio. A transceiver or network interface 420 transmits and receives signals between computer system 400 and other devices, such as another user device, a chat server, or a payment provider server via network 136. In one embodiment, the transmission is wireless, although other transmission mediums and methods may also be suitable. A processor 414, which can be a micro-controller, digital signal processor (DSP), or other processing component, processes these various signals, such as for display on computer system 400 or transmission to other devices via a communication link 424. Processor 414 may also control transmission of information, such as cookies or IP addresses, to other devices.

Components of computer system 400 also include a system memory component 410 (e.g., RAM), a static storage component 416 (e.g., ROM), and/or a disk drive 418. Computer system 400 performs specific operations by processor 414 and other components by executing one or more sequences of instructions contained in system memory component 410. Logic may be encoded in a computer readable medium, which may refer to any medium that participates in providing instructions to processor 414 for execution. Such a medium may take many forms, including but not limited to, non-volatile media, volatile media, and transmission media. In various implementations, non-volatile media includes optical or magnetic disks, volatile media includes dynamic memory, such as system memory component 410, and transmission media includes coaxial cables, copper wire, and fiber optics, including wires that comprise bus 412. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 424 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a memory device storing user account information, wherein the user account information comprises financial information for a first and second user account; and
one or more hardware processors operable to:
receive instructions from the first user to configure a chat session to accept actionable text regarding payment;
receive the actionable text in a message entered by the first user to the second user;
determine an action for the first user based on the actionable text;
transmit a request for the action to the second user;
receive approval of the request from the second user; and
process the payment.

2. The system of claim 1, wherein the actionable text comprises emoticons, a string of letters, symbols, and/or numbers, or a combination thereof.

3. The system of claim 1, wherein the actionable text is quantified to correlate to a certain payment amount.

4. The system of claim 1, wherein the one or more processors is further operable to transfer funds to or from the second user account.

5. The system of claim 4, wherein the one or more processors is further operable to notify the first user, second user, or both after the payment is processed.

6. The system of claim 1, wherein the one or more processors is further operable to convert currency in the actionable text from the first user to another currency in the request to the second user.

7. The system of claim 6, wherein the one or more processors converts the currency based on a location of a user device.

8. The system of claim 1, wherein the one or more processors is further operable to receive a second message from the first user with actionable text for a second payment amount different from a first payment amount.

9. The system of claim 1, wherein the one ore more processors is further operable to transmit and process a second request regarding payment to the second user.

10. A non-transitory machine-readable medium comprising a plurality of machine-readable instructions which when executed by one or more processors of a server are adapted to cause the server to perform a method comprising:
receiving instructions from a first user to configure a chat session to accept actionable text regarding payment;
receiving the actionable text in a message entered by the first user to a second user;
determining an action for the first user based on the actionable text;
transmitting a request for the action to the second user;
receiving approval of the request from the second user; and
processing the payment.

11. The non-transitory machine-readable medium of claim 10, wherein the actionable text comprises emoticons, a string of letters, symbols, and/or numbers, or a combination thereof.

12. The non-transitory machine-readable medium of claim 10, wherein the actionable text is quantified to correlate to a certain payment amount.

13. The non-transitory machine-readable medium of claim 10, wherein processing the payment comprises transferring funds to or from an account of the second user.

14. The non-transitory machine-readable medium of claim 10, further comprising notifying the first user, second user, or both after the payment is processed.

15. A method of facilitating payments in a chat session comprising:
receiving, electronically by a hardware processor of a service provider, instructions from a first user to configure the chat session to accept actionable text regarding payment;
receiving the actionable text in a message entered by the first user to the second user;
determining an action for the first user based on the actionable text;
transmitting a request for the action to the second user;
receiving approval of the request from the second user; and
processing the payment.

16. The method of claim 15, wherein the actionable text comprises emoticons, a string of letter, symbols, and/or numbers, or a combination thereof.

17. The method of claim 15, wherein the actionable text is quantified to correlate to a certain payment amount.

18. The method of claim 15, wherein processing the payment comprises transferring funds to or from an account of the second user.

19. The method of claim 15, further comprising converting currency in the actionable text from the first user to another currency in the request to the second user.

20. The method of claim 19, wherein the currency is converted based on a location of a user device.
